(19) United States
(12) Patent Application Publication
(10) Pub. No.: US 2026/0267600 A1
(43) Pub. Date: Sep. 10, 2026

(54) Method and System for Providing a Vehicle Display with Proactive Message

(71) Applicant: Bayerische Motoren Werke Aktiengesellschaft, Muenchen (DE)

(72) Inventors: Mathias Ordung, Muenchen (DE); Rupert Spielvogel, Berlin (DE)

(21) Appl. No.: 19/164,954

(22) PCT Filed: Jan. 16, 2024
(86) PCT No.: PCT/EP2024/050899

§ 371 Date: Sep. 12, 2025

(30) Foreign Application Priority Data
Mar. 20, 2023 (DE) 10 2023 106 869.5

(51) Int. Cl. G06F 3/16; B60K 35/10; B60K 35/22; B60K 35/28; G06F 3/01; G10L 15/22

(52) U.S. Cl. CPC G06F 3/167; B60K 35/10; B60K 35/22; B60K 35/28; G06F 3/013; G10L 15/22; B60K 2360/148; G10L 2015/223

(57) ABSTRACT

A method is disclosed herein for providing a proactive message on a display of a vehicle. The method includes providing a representation of a digital voice assistant of the vehicle on a display in a field of view of a user of the vehicle, determining the proactive message by the digital voice assistant of the vehicle, and adapting the representation of the digital voice assistant of the vehicle depending on the proactive message on the vehicle's display. Additionally, the method includes detecting a line of sight of the user of the vehicle towards the adapted representation of the digital voice assistant by an interior camera of the vehicle, and activating a voice recognition system of the digital voice assistant after detection of the line of sight of the user of the vehicle towards the adapted representation of the digital voice assistant on the vehicle's display. The method further includes receiving a voice message from the user of the vehicle by the voice recognition system of the digital voice assistant of the vehicle, and providing the proactive message on the vehicle's display depending on the voice message received from the user of the vehicle.

### CROSS-REFERENCE TO RELATED APPLICATIONS

The present application is the U.S. national phase of PCT Application PCT/EP2024/050899 filed on Jan. 16, 2024, which claims priority of German patent application No. 10 2023 106 869.5 filed on Mar. 20, 2023, the entire contents of which are incorporated herein by reference.

### FIELD

The present disclosure relates to the field of vehicles, and particularly to a method for providing a proactive message on a display of a vehicle.

### BACKGROUND

Digital voice assistants that can display a proactive message in a pop-up window on a display in the vehicle are known from the prior art. A user of the vehicle has no influence on when the proactive message from the digital voice assistant is displayed to the user.

It would therefore be advantageous to provide a proactive message from a digital voice assistant to a user of the vehicle in a more efficient manner and in a manner that is more easily controlled by the user.

### SUMMARY

According to a first aspect of the disclosure, a method is disclosed for providing a proactive message on a display of a vehicle. The method may be a method implemented by a computer and/or a method implemented by a control unit. The vehicle's display may be a display, a touch display and/or a heads-up display of a vehicle. The proactive message may be a message that is proactively provided by a digital voice assistant. of the vehicle to a user of the vehicle, preferably to a driver of the vehicle. The proactive message may, for example, comprise suggestions, hints, information, (operating) prompts, and/or interaction options relating to vehicle functions and/or driver assistance functions.

The method comprises provision of a representation of a digital voice assistant of the vehicle on a display in a field of view of a user of the vehicle. The representation may be a visual or audiovisual representation of the digital voice assistant. The representation may represent a state of the digital voice assistant. For example, the representation may represent an inactive state of the digital voice assistant. The user may be a driver, a front-seat passenger, or an occupant of the vehicle. Preferably, the user is the driver of the vehicle. The method further comprises determination of the proactive message by the digital voice assistant of the vehicle, and adaptation of the representation of the digital voice assistant of the vehicle depending on the proactive message on the vehicle's display. The representation of the digital voice assistant can be adapted depending on a change in the state of the digital voice assistant. If the state of the digital voice assistant changes, the visual or audiovisual representation of the digital voice assistant on the vehicle's display can be adapted according to the change of state.

The method further comprises detection of a line of sight representation of the digital voice assistant by an interior camera of the vehicle. The interior camera may be a camera for monitoring the driver of the vehicle. The interior camera may be an RGB camera, an IR camera, and/or a combined RGB-IR camera. The method further comprises activation of a voice recognition system of the digital voice assistant after detection of the line of sight of the user of the vehicle towards the adapted representation of the digital voice assistant on the vehicle's display, receipt of a voice message from the user of the vehicle by the voice recognition system of the digital voice assistant of the vehicle, and provision of the proactive message on the vehicle's display depending on the voice message received from the user of the vehicle.

Advantageously, the method can efficiently provide a proactive message to a user of the vehicle. The user of the vehicle can retrieve and display a proactive message from the digital voice assistant by looking towards the representation of the digital voice assistant. This increases the acceptance of proactive messages from the digital voice assistant by the user. Furthermore, the digital voice assistant efficiently prevents safety-critical interruptions to the user of the vehicle, in particular the driver of the vehicle. In addition, the provision of a proactive message from the digital voice assistant to the user of the vehicle can be efficiently simplified.

According to one advantageous configuration, the proactive message may comprise one or more situationally appropriate suggestions for using one or more vehicle functions and/or one or more driver assistance functions of the vehicle to the user of the vehicle. This allows a user of the vehicle to efficiently provide situationally appropriate suggestions on the vehicle's display in a manner controlled by the user.

According to a further advantageous configuration, the representation of the digital voice assistant may be a visual representation of the digital voice assistant on the vehicle's display, and/or the visual representation of the digital voice assistant may be a constantly inactive visual representation of the digital voice assistant on the vehicle's display. This makes it easier for the user of the vehicle to see the digital voice assistant of the vehicle on the vehicle's display without the user of the vehicle being distracted from the driving task.

According to a further advantageous configuration, the proactive message can be determined by the digital voice assistant of the vehicle depending on £ contextual information and/or an event, and/or the contextual information can be representative of a vehicle context, a driving context, and/or an environment of the vehicle. This enables the digital voice assistant to efficiently determine a relevant, proactive message for provision to the user of the vehicle.

According to a further advantageous configuration, the adaptation of the representation of the digital voice assistant of the vehicle depending on the proactive message on the vehicle's display may comprise adapting the visual representation of the digital voice assistant, wherein the adapted visual representation of the digital voice assistant is representative of a prompt to the user to provide the proactive message from the digital voice assistant on the vehicle's display.

This allows a proactive message for provision to be without distracting the user of the vehicle from the driving task.

According to a further advantageous configuration, the activation of the voice recognition system of the digital voice assistant after detection of the line of sight of the user of the vehicle towards the adapted representation of the digital voice assistant on the vehicle's display may comprise automatically activating the voice recognition system of the digital voice assistant without a wake-up word of the digital voice assistant. This allows the user of the vehicle to efficiently retrieve the proactive message from the digital voice assistant.

According to a further advantageous configuration, the voice recognition system of the digital voice assistant can be activated automatically for a predetermined time interval, and the voice recognition system can preferably be deactivated automatically after the predetermined time interval has elapsed. This allows the voice recognition system to be controlled efficiently for retrieving and/or providing the proactive message from the digital assistant on the vehicle's display.

According to a further advantageous configuration, the voice message received from the user of the vehicle by the voice recognition system of the digital voice assistant of the vehicle may comprise a voice command that controls the provision of the proactive message from the digital voice assistant of the vehicle on the vehicle's display, and the proactive message is provided on the vehicle's display depending on the voice command received from the user of the vehicle. This allows the retrieval and/or provision to be controlled efficiently in a user-specific manner using a voice command.

According to a further advantageous configuration, the proactive message can be provided on the vehicle's display depending on the voice message received from the user of the vehicle and on the effort required in terms of time or complexity for an activity associated with the proactive message. This allows the provision of the proactive message to be controlled efficiently without overwhelming the user of the vehicle and/or distracting them from the driving task.

According to a further aspect, the disclosure herein is characterized by a computer-readable medium for providing a proactive message on a display of a vehicle, wherein the computer-readable medium comprises instructions which, when executed on a control device or a computer of the vehicle, carry out the above-described method.

According to a further aspect, the disclosure herein is characterized by a system for providing a proactive message on a display of a vehicle, wherein the system is designed to carry out the above-described method.

According to a further aspect, the disclosure herein is characterized by a vehicle comprising the above-described system for providing a proactive message on a display of a vehicle.

Further features of the disclosure are apparent from the claims, the figures and the description of the figures. All features and combinations of features mentioned above in the description, as well as the features and combinations of features mentioned below in the description of the figures and/or shown in the figures alone, are usable not only in the combination specified in each case, but also in other combinations or in isolation.

### BRIEF DESCRIPTION OF THE DRAWINGS

The following describes an exemplary embodiment of the disclosure with reference to the accompanying drawings. This provides further details, preferred configurations and developments of the disclosure. In particular,

FIG. 1 shows an example method for providing a proactive message on a display of a vehicle, and

FIG. 2 shows an example sequence of the method on a display of a vehicle.

### DESCRIPTION

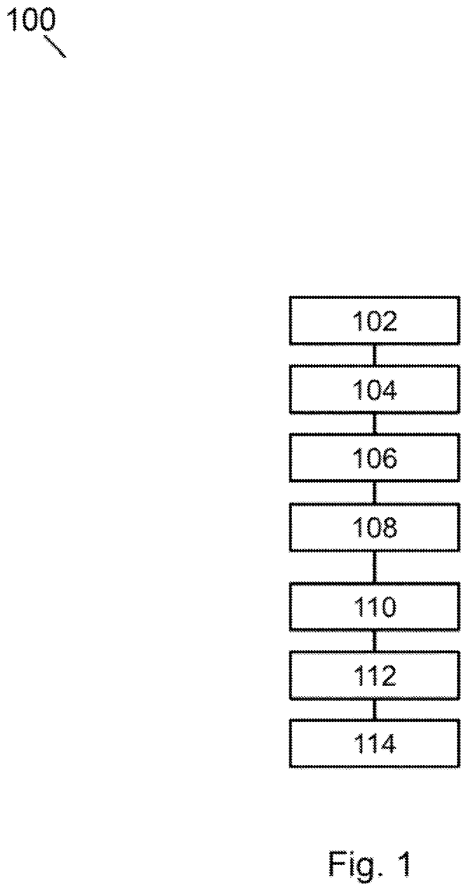

FIG. 1 shows in detail an example method 100 for providing a proactive message on a display of a vehicle. An example of a proactive message is a proactive message with a suggestion for using a vehicle function that is appropriate to the situation but preferably not time-critical.

The method can provide a representation of a digital voice assistant of the vehicle on a display in a field of view of a user of the vehicle 102. The user of the vehicle is preferably a driver of the vehicle. The representation of the digital voice assistant of the vehicle can be provided at a fixed position of a display in the field of view of a driver of the vehicle. Preferably, the representation of the digital voice assistant is constantly inactive, i.e. the representation of the digital voice assistant comprises a visual representation of the digital voice assistant that has no animation or only an animation that is provided in the driver's field of view slowly and without distracting the driver.

The method 100 can determine the proactive message by means of the digital voice assistant of the vehicle 104. The proactive message can be determined by the digital voice assistant in a manner appropriate to the situation. For example, depending on the current driving situation, the digital voice assistant can determine a suggestion for using a driver assistance function as the content of a proactive message.

The method 100 can adapt the representation of the digital voice assistant of the vehicle depending on the proactive message on the vehicle's display 106. The adaptation of the representation of the digital voice assistant of the vehicle can comprise adapting the visual or audiovisual representation of the digital voice assistant. The representation of the digital assistant can be adapted so that, in the field of view of the driver of the vehicle, the constantly inactive representation is adapted in such a way that the driver is alerted to the presence of a proactive message. For example, the adaptation of the representation may comprise increasing the speed of an animation of the digital voice assistant and/or changing a shape, color and/or appearance of the visual representation of the digital voice assistant. In addition or alternatively, the visual representation of the digital assistant may be supplemented by symbol, wherein the symbol is representative of the presence of the proactive message. Preferably, the representation of the digital assistant is adapted so that the user of the vehicle, in particular the driver of the vehicle, is not distracted from the driving task and/or interrupted while performing a current activity, for example while performing a current user interaction with the vehicle.

The method 100 can further detect a line of sight of the user of the vehicle towards the adapted representation of the digital voice assistant by means of an interior camera of the vehicle 108 and activate a voice recognition system of the digital voice assistant after detection of the line of sight of the user of the vehicle towards the adapted representation of the digital voice assistant on the vehicle's display 110. Furthermore, the activation of the voice recognition system of the digital voice assistant after detection of the line of sight of the user of the vehicle towards the adapted representation of the digital voice assistant on the vehicle's display may comprise automatically activating the voice recognition system of the digital voice assistant without a wake-up word of the digital voice assistant. A glance by the user with the detected line of sight can be used to automatically activate the voice recognition system if the user's eyes remain on the adapted representation of the digital voice assistant for longer than a predetermined threshold value. This prevents the user's wandering eyes which do not remain fixed on the adapted representation of the digital voice assistant from unintentionally activating the voice recognition system automatically. The voice recognition system of the digital voice assistant can be activated automatically for a predetermined time interval and deactivated automatically after the predetermined time interval has elapsed.

In addition or as an alternative, the user of the vehicle can activate the voice recognition system of the digital voice assistant of the vehicle using a push-to-talk control element on a steering wheel of the vehicle. If the line of sight of the user of the vehicle towards the adapted representation of the digital voice assistant cannot be detected, the user can alternatively activate the voice recognition system without a wake-up word using the push-to-talk control element.

The method can receive a voice message from the user of the vehicle by means of the voice recognition system of the digital voice assistant of the vehicle 112. The voice message received from the user of the vehicle by the voice recognition system of the digital voice assistant of the vehicle may comprise a voice command that controls the provision of the proactive message from the digital voice assistant of the vehicle on the vehicle's display. The voice message preferably comprises an interaction pattern that indicates to the digital voice assistant that the user wishes the proactive message to be provided. The interaction pattern may depend on a language and/or a language style. For example, the language and/or language style may be stored in a profile of the user of the vehicle, and the digital voice assistant may evaluate the voice message using the language stored in the user profile and/or the language style stored in the user profile. For example, the user may use the voice message ‘Yes, please’ to express a desire for the digital voice assistant to provide the proactive message. The voice message ‘Yes, please’ can be interpreted and/or executed by the digital voice assistant as a voice command to provide the proactive message.

The method 100 can provide the proactive message on the vehicle's display depending on the voice message received from the user of the vehicle 112. In detail, the proactive message can be provided on the vehicle's display depending on the voice command received from the user of the vehicle. Furthermore, the proactive message can be provided on the vehicle's display depending on the voice message received from the user of the vehicle and on the effort required in terms of time and/or complexity for an activity associated with the proactive message. For example, a graphical user interface of the vehicle may have various graphical display elements and/or graphical menu structures that can be used to provide the proactive message on the vehicle's display. The graphical display elements and/or graphical menu structures for providing the proactive message may change depending on the effort required in terms of time and/or complexity for an activity associated with the proactive message. In addition, the representation of the digital voice assistant when the proactive message is provided can be readjusted, the readjustment of the representation of the digital voice assistant representing the provision of the proactive message to the user of the vehicle.

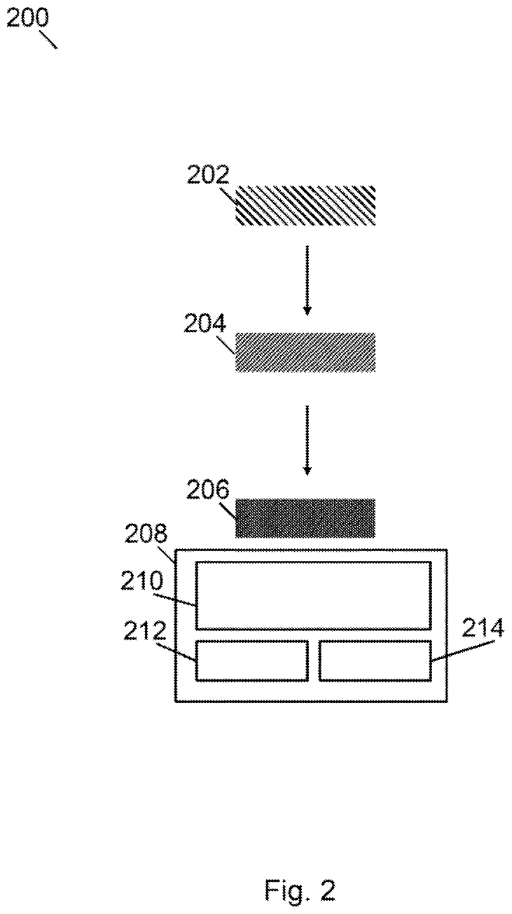

FIG. 2 shows in detail an example sequence 200 of the method 100 on a display of a vehicle. The method first displays a representation 202 of the digital voice assistant on the display. The representation 204 of the digital voice assistant shows, as an example, adaptation of the representation 202 of the digital voice assistant after determination of the proactive message to be provided. The representation 206 of the digital voice assistant shows, as an example, readjustment of the digital representation 204 when the proactive message 208 is provided. The proactive message 208 may comprise a suggestion 210 and one or more buttons 212, 214 for easily accepting or rejecting the suggestion of the proactive message.

Advantageously, the user of the vehicle can individually control the provision of a proactive message. The user can communicate with the digital voice assistant without a wake-up word and control the provision of the proactive voice message. The user can individually decide when the user is ready to receive the proactive message. This can efficiently increase user acceptance of a proactive message in the vehicle. Furthermore, any distraction of the user from a driving task when a proactive message is provided can be efficiently reduced.

### LIST OF REFERENCE SIGNS

100 Method
102 Provision of a representation of a digital voice assistant
104 Determination of a proactive message
106 Adaptation of a representation of the digital voice assistant
108 Detection of a line of sight
110 Activation of a voice recognition system
112 Receipt of a voice message
114 Provision of a proactive message
200 Sequence
202 Representation of a digital voice assistant
204 Representation of a digital voice assistant
206 Representation of a digital voice assistant
208 Proactive message
210 Suggestion
212 Button
214 Button

1-12. (canceled)

13. A method for providing a proactive message on a display of a vehicle, the method comprising:
providing a representation of a digital voice assistant of the vehicle on a display in a field of view of a user of the vehicle;
determining the proactive message by the digital voice assistant of the vehicle;
adapting the representation of the digital voice assistant of the vehicle depending on the proactive message on the vehicle's display;
detecting a line of sight of the user of the vehicle towards the adapted representation of the digital voice assistant by an interior camera of the vehicle;
activating a voice recognition system of the digital voice assistant after detection of the line of sight of the user of the vehicle towards the adapted representation of the digital voice assistant on the vehicle's display;
receiving a voice message from the user of the vehicle by the voice recognition system of the digital voice assistant of the vehicle; and
providing the proactive message on the vehicle's display depending on the voice message received from the user of the vehicle.

14. The method as claimed in claim 13, wherein the proactive message comprises one or more situationally appropriate suggestions for using one or more vehicle functions or one or more driver assistance functions of the vehicle to the user of the vehicle.

15. The method as claimed in claim 14, wherein the representation of the digital voice assistant is a visual representation of the digital voice assistant on the vehicle's display; and
wherein the visual representation of the digital voice assistant is a constantly inactive visual representation of the digital voice assistant on the vehicle's display.

16. The method as claimed in claim 15, wherein the proactive message is determined by the digital voice assistant of the vehicle depending on at least one of contextual information and an event; and
wherein the contextual information is representative of at least one of a vehicle context, a driving context and an environment of the vehicle.

17. The method as claimed in claim 15, wherein adapting the representation of the digital voice assistant of the vehicle depending on the proactive message on the vehicle's display comprises adapting the visual representation of the digital voice assistant, wherein the adapted visual representation of the digital voice assistant is representative of a prompt to the user to provide the proactive message from the digital voice assistant on the vehicle's display.

18. The method as claimed in claim 17, wherein activating the voice recognition system of the digital voice assistant after detection of the line of sight of the user of the vehicle towards the adapted representation of the digital voice assistant on the vehicle's display comprises automatically activating the voice recognition system of the digital voice assistant without a wake-up word of the digital voice assistant.

19. The method as claimed in claim 17, wherein the voice recognition system of the digital voice assistant is activated automatically for a predetermined time interval; and
wherein the voice recognition system is deactivated automatically after the predetermined time interval has elapsed.

20. The method as claimed in claim 17, wherein the voice message received from the user of the vehicle by the voice recognition system of the digital voice assistant of the vehicle comprises a voice command that controls the provision of the proactive message from the digital voice assistant of the vehicle on the vehicle's display; and
wherein the proactive message is provided on the vehicle's display depending on the voice command received from the user of the vehicle.

21. The method as claimed in claim 13, wherein the proactive message is provided on the vehicle's display depending on the voice message received from the user of the vehicle and on an effort required in terms of at least one of time and complexity for an activity associated with the proactive message.

22. A non-transitory computer-readable medium for providing a proactive message on a display of a vehicle, wherein the computer-readable medium comprises instructions which, when executed on a controller of the vehicle, causes the controller to:
provide a representation of a digital voice assistant of the vehicle on a display in a field of view of a user of the vehicle;
determine the proactive message by the digital voice assistant of the vehicle;
adapt the representation of the digital voice assistant of the vehicle depending on the proactive message on the vehicle's display;
detect a line of sight of the user of the vehicle towards the adapted representation of the digital voice assistant by an interior camera of the vehicle;
activate a voice recognition system of the digital voice assistant after detection of the line of sight of the user of the vehicle towards the adapted representation of the digital voice assistant on the vehicle's display;
receive a voice message from the user of the vehicle by the voice recognition system of the digital voice assistant of the vehicle; and
provide the proactive message on the vehicle's display depending on the voice message received from the user of the vehicle.

23. The computer-readable medium as claimed in claim 22, wherein the proactive message comprises one or more situationally appropriate suggestions for using one or more vehicle functions or one or more driver assistance functions of the vehicle to the user of the vehicle.

24. The computer-readable medium as claimed in claim 23, wherein the representation of the digital voice assistant is a visual representation of the digital voice assistant on the vehicle's display; and
wherein the visual representation of the digital voice assistant is a constantly inactive visual representation of the digital voice assistant on the vehicle's display.

25. The computer-readable medium as claimed in claim 24, wherein the proactive message is determined by the digital voice assistant of the vehicle depending on at least one of contextual information and an event; and
wherein the contextual information is representative of at least one of a vehicle context, a driving context and an environment of the vehicle.

26. The computer-readable medium as claimed in claim 25, wherein the instructions cause the controller to adapt the representation of the digital voice assistant of the vehicle depending on the proactive message on the vehicle's display by adapting the visual representation of the digital voice assistant, wherein the adapted visual representation of the digital voice assistant is representative of a prompt to the user to provide the proactive message from the digital voice assistant on the vehicle's display.

27. The computer-readable medium as claimed in claim 26, wherein the instructions cause the controller to activate the voice recognition system of the digital voice assistant after detection of the line of sight of the user of the vehicle towards the adapted representation of the digital voice assistant on the vehicle's display by automatically activating the voice recognition system of the digital voice assistant without a wake-up word of the digital voice assistant.

28. The computer-readable medium as claimed in claim 26, wherein the instructions cause the controller to:
activate the voice recognition system of the digital voice assistant automatically for a predetermined time interval; and
automatically deactivate the voice recognition system after the predetermined time interval has elapsed.

29. The computer-readable medium as claimed in claim as claimed in claim 26, wherein the voice message received from the user of the vehicle by the voice recognition system of the digital voice assistant of the vehicle comprises a voice command that controls the provision of the proactive message from the digital voice assistant of the vehicle on the vehicle's display; and
wherein the proactive message is provided on the vehicle's display depending on the voice command received from the user of the vehicle.

30. The computer-readable medium as claimed in claim 26, wherein the instructions cause the controller to provide the proactive message on the vehicle's display depending on the voice message received from the user of the vehicle and on an effort required in terms of at least one of time and complexity for an activity associated with the proactive message.

31. A vehicle comprising a system for providing a proactive message on a display of a vehicle, wherein the vehicle comprises:
a digital voice assistant having a voice recognition system;
an interior camera; and
a controller configured to:
provide a representation of the digital voice assistant of the vehicle on the display in a field of view of a user of the vehicle;
determine the proactive message by the digital voice assistant of the vehicle;
adapt the representation of the digital voice assistant of the vehicle depending on the proactive message on the vehicle's display;
detect a line of sight of the user of the vehicle towards the adapted representation of the digital voice assistant by an interior camera of the vehicle;
activate the voice recognition system of the digital voice assistant after detection of the line of sight of the user of the vehicle towards the adapted representation of the digital voice assistant on the vehicle's display;
receive a voice message from the user of the vehicle by the voice recognition system of the digital voice assistant of the vehicle; and
provide the proactive message on the vehicle's display depending on the voice message received from the user of the vehicle.
